(19) United States
(12) Patent Application Publication
(10) Pub. No.: US 2026/0012890 A1
(43) Pub. Date: Jan. 8, 2026

(54) CONTROLLING PROCESSING RESOURCES

(71) Applicant: Telefonaktiebolaget LM Ericsson (publ), Stockholm (SE)

(72) Inventors: Tomas Lagerqvist, Stockholm (SE); Stefan Tjärnlund, Järfälla (SE); My Nordenström, Stockholm (SE)

(21) Appl. No.: 18/992,613

(22) PCT Filed: Jul. 13, 2022
(86) PCT No.: PCT/EP2022/069687

§ 371 Date: Jan. 9, 2025

(51) Int. Cl. H04W 52/02; H04L 47/22

(52) U.S. Cl. CPC H04W 52/0235; H04L 47/22

(57) ABSTRACT

A method of a controller device of controlling processing resources of processing units being assigned to serve wireless communication devices in a radio access network is provided. The method comprises determining a traffic load of the served wireless communication devices, determining whether or not a subset of the processing units have sufficient processing capacity to serve the wireless communication devices based on the determined traffic load, and if so setting at least one selected processing unit not included in said subset of processing units in low-power mode, and assigning to one or more processing units included in said subset to take over serving of any wireless communication device served by the at least one selected processing unit being set in low-power mode.

### TECHNICAL FIELD

The present disclosure relates to a method of a controller device of controlling processing resources of processing units being assigned to serve wireless communication devices in a radio access network, and a controller device performing the method.

### BACKGROUND

In mobile communications systems, such as fourth generation (4G) Long Term Evolution (LTE) or fifth generation (5G) New Radio (NR), power consumption is an important metric, as energy cost is a substantial part of the total cost of a system operator.

Normally, resources for handling physical layer processing are dimensioned to handle a peak load scenario. However, from a long-term, average point of view, instantaneous traffic load is typically much lower than at a peak condition. Nevertheless, the processing resources are dimensioned to handle the peak scenario at a short notice.

### SUMMARY

One objective is to solve, or at least mitigate, this problem in the art and thus to provide an improved method of controlling processing resources of processing units being assigned to serve wireless communication devices in a radio access network.

This objective is attained in a first aspect by a method of a controller device of controlling processing resources of processing units being assigned to serve wireless communication devices in a radio access network. The method comprises determining a traffic load of the served wireless communication devices, determining whether or not a subset of the processing units have sufficient processing capacity to serve the wireless communication devices based on the determined traffic load, and if so setting at least one selected processing unit not included in said subset of processing units in low-power mode, and assigning to one or more processing units included in said subset to take over serving of any wireless communication device served by the at least one selected processing unit being set in low-power mode.

This objective is attained in a second aspect by a controller device configured to control processing resources of processing units being assigned to serve wireless communication devices in a radio access network. The device comprising a processing unit and a memory, said memory containing instructions executable by said processing unit, whereby the device is operative to determine a traffic load of the served wireless communication devices, determine whether or not a subset of the processing units have sufficient processing capacity to serve the wireless communication devices based on the determined traffic load, and if so to set at least one selected processing unit not included in said subset of processing units in low-power mode, and to assign to one or more processing units included in said subset to take over serving of any wireless communication device served by the at least one selected processing unit being set in low-power mode.

Assuming for instance that a first processing unit in a subset serves a first and second wireless communication devices in a group of wireless communication devices. Assuming further that another three processing units in the subset are determined to have processing capacity to serve all wireless communication devices in a group, the controller device will advantageously set the first processing unit in a low-power mode and assign to one of the other processing units in the subset to take over the serving of the first and second wireless communication devices.

Advantageously, the total power consumption of the four processing units in the subset has been greatly reduced while still providing processing capacity to serve all wireless communication devices.

In an embodiment, the assigning to one or more processing units included in said subset to take over serving of any wireless communication device served by the at least one selected processing unit being set in low-power mode comprises controlling a switched fronthaul configured to connect the processing units to the wireless communication devices to be served to switch said any wireless communication device to the one or more processing units included in said subset being assigned to take over the serving.

In an embodiment, the method further comprises instructing the at least one selected processing unit where to write required data for said any wireless communication device in a memory common to the processing units before being set in low-power mode and instructing said one or more processing units included in said subset assigned to take over serving of said any wireless communication device where to read the required data in the common memory.

In an embodiment, the subset of the processing units is determined to have sufficient processing capacity to serve the wireless communication devices if the determined traffic load does not exceed a first load threshold value.

In an embodiment, the method further comprises determining whether or not a subset of the processing units still have sufficient processing capacity to serve the wireless communication devices based on a new determined traffic load, and if not reassigning to said at least one selected processing unit being set in low-power mode to serve one or more of the wireless communication devices currently served by one or more processing units included in said subset.

In an embodiment, the subset of the processing units is determined to not still have sufficient processing capacity to serve the wireless communication devices if the determined traffic load exceeds a second load threshold value.

In an embodiment, the determining of a traffic load of the served wireless communication devices comprises determining instantaneous traffic load or traffic load averaged over a time period, or estimating the traffic load from historical traffic load.

In an embodiment, the assigning to one or more processing units included in said subset to take over serving of any wireless communication device served by the at least one selected processing unit being set in low-power mode comprises assigning to said one or more processing units included in said subset to take over processing of cell-specific channels.

In a third aspect, a computer program is provided comprising computer-executable instructions for causing a controller device to perform steps recited in the method according to the first aspect when the computer-executable instructions are executed on a processing unit included in the controller device.

In a fourth aspect, a computer program product comprising a computer readable medium is provided, the computer readable medium having the computer program according to the third aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a communications system comprising a controller device according to an embodiment;

FIG. 2 illustrates average traffic load caused by wireless communication devices over a time period;

FIG. 3 shows a flowchart illustrating a method of the controller device of controlling processing resources of processing units being assigned to serve the wireless communication devices in an embodiment;

FIG. 4 shows a flowchart illustrating the method in a further embodiment;

FIG. 5 shows a flowchart illustrating the method in yet a further embodiment; and

FIG. 6 illustrates a controller device according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

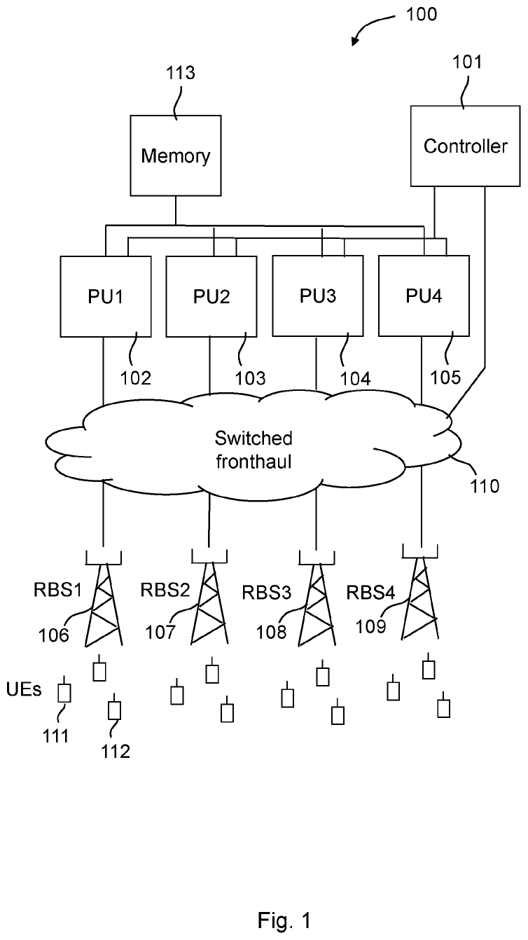

FIG. 1 illustrates a communications system 100 comprising a controller device 101 according to an embodiment to be described in more detail in the following.

The communications system 100 comprises a plurality of processing units 102-105 (PUs) serving a plurality of radio base stations 106-109 (RBSs) and wireless communication devices, commonly referred to as user equipment (UE), in a radio access network (RAN) via switched fronthaul 110. The UEs may be embodied in the form of smart phones, tables, connected vehicles, etc.

Thus the PUs 102-105 perform baseband processing at the physical layer, also referred to as layer 1 (L1) processing. The PUS 102-105 may be embodied in the form of microprocessors, digital signal processors (DSPs), application specific integrated circuits (ASICs), field-programmable gate arrays (FPGAs), complex programmable logic devices (CPLDs), etc. As is understood, the PUs may be separate chips or implemented as a multi-chip module (MCM).

In the art, the PUs 102-105 serving the RBSs 106-109 and the UEs are selected to have a sufficient capacity for performing the baseband processing during a peak traffic load scenario for the UEs.

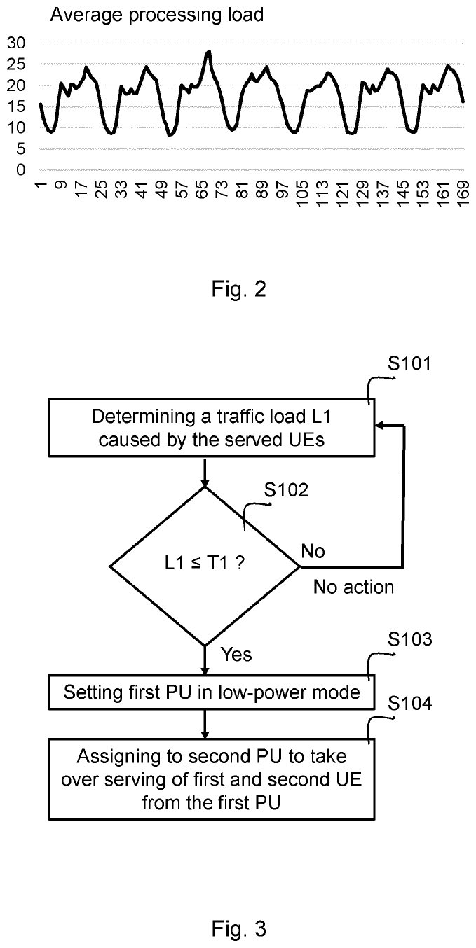

As illustrated in FIG. 2, average traffic load caused by the UEs served by the RBSs 106-109 over one week, and corresponding processing load at the PUs 102-105, vary greatly over time. As can be seen in FIG. 2, the processing load varies between just under 10 units and almost 30 units. In other words, during a traffic peak scenario, the processing load of the PUs 102-105 may be a factor 3 times the load during low-traffic periods.

Typically, at night-time the traffic load is much lower than the traffic load occurring during daytime peak hours.

Thus, to provide hardware such as the PUs 102-105 activated to serve traffic peaks occurring at short notice results in a high power consumption even if the average utilization is low. Again with refence to FIG. 2, even if the average load on the PUs 102-105 is somewhere around 16-17 load units, the PUs are in practice prepared to instantly handle a peak load of 27-28 load units.

In general, energy consumed by the PUs 102-105 being e.g. microprocessors or ASIC consists of two parts:
1) dynamic energy, and
2) static energy (leakage and energy consumption caused e.g. by infrastructure-related clock toggle which is always present regardless of processing load)

Thus, even if the dynamic processing load is low, the PUs 102-105 will still consume energy due to static power consumption.

Again with reference to FIG. 1 and further with reference to the flowchart of FIG. 3 illustrating a method of the controller device 101 of controlling processing resources of the PUs 102-105 being assigned to serve the UEs in the RAN, this issue is resolved by the controller 101 performing the method in an embodiment.

As is understood, while the PUs 102-105 operate at L1, the controller 102 typically operates at the second layer (L2), also referred to as data link layer. The controller 101 implements a medium access control (MAC) scheduler as well as a backhaul connection and user plane data processing.

In a first step S101, the controller 101 determines a traffic load of the UEs being served by the PUs 102-105.

Assuming for instance that the controller 101 determines in step S102 that a traffic load L1 of the UEs being served by the PUs 102-105 via the RBSs 106-109 currently does not exceed a first load threshold value T1, i.e. L1≤T1, which threshold value T1 corresponds to a maximum traffic load that a subset of the PUs (such as e.g. three PUs has processing capacity to handle.

In other words, should the determined traffic load L1 of the UEs exceed the first load threshold value T1, i.e. L1>T1, all four PUs would have to be involved in the baseband processing in order to provide sufficient processing capacity for serving all the UEs given the current traffic load L1.

However, in this embodiment, since the controller 101 determines in step S102 that the traffic load L1 caused by the UEs is low enough to only require processing resources of three PUs, a remaining PU may in step S103 be set in a low-power mode to reduce energy consumption of the system.

In this particular example, assuming that first PU 102 serves first UE 111 and second UE 112; since the three PUs 103-105 indeed is determined in step S102 to have processing capacity to serve all UEs given that L1≤T1, the controller 101 will advantageously in step S103 set the first PU 102 in a low-power mode and assign to one of the PUs 103-105 in the subset, such as the second PU 103, to take over the serving of the first UE 111 and second UE 112.

Should L1>T1 as determined in step S102, no re-assignment of UEs will be performed and all four PUS 102-105 will continue to serve the UEs.

Advantageously, with this embodiment, the power consumption of the four PUS 102-105 has been greatly reduced while still providing processing capacity to serve all UEs given the current traffic load. Hence, in this particular example second, third and fourth PU 103-105 can be used by the MAC scheduler of the controller 101, while the first PU 102 is powered-down and not used until being powered-up again.

Should the traffic load L1 of the UEs not exceed a still lower set load threshold value, a further PU may be powered down, and so on, until only one PU serves the UEs.

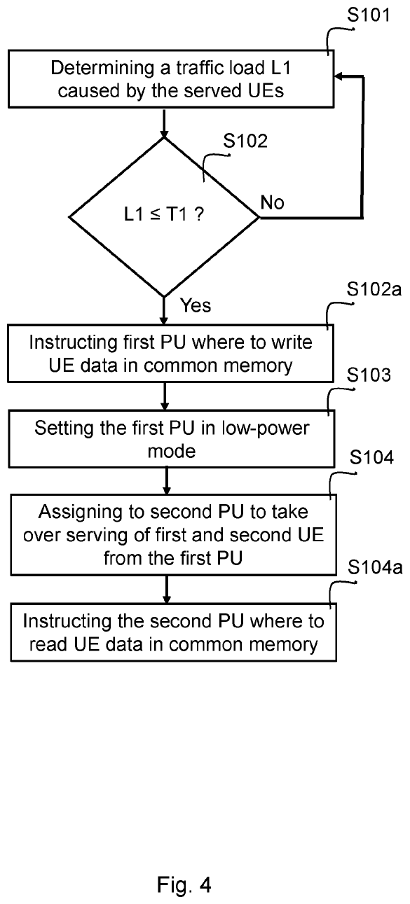

FIG. 4 illustrates a flowchart of the method in another embodiment. If utilizing the particular network structure illustrated in FIG. 1, the assigning in step S104 to the second PU 103 to take over the serving of the first UE 111 and the second UE 112 from the first PU 102 is performed by the controller 101 controlling the switched fronthaul 110 to switch the first UE 111 and the second UE 112 out of connection with the first PU 102 and into connection with the second PU 103. Advantageously, the switched fronthaul facilitates any UE being switched into connection with any PU 102-105.

In a further embodiment, the PUs 102-105 have access to a common memory 113, to/from which the PUS 102-105 may write/read useful data.

For instance, if the take-over of the second PU 103 of the serving of the first UE 111 and the second UE 112 from the first PU 102 requires access to any current data of the first UE 111 and the second UE 112 processed by the first PU 102—for instance cell-specific data or state-type data such as uplink hybrid automatic repeat request (HARQ) being UE-specific information—the first PU 102 may store such data in the common memory 113 for subsequent access by the second PU 103.

The controller 101 may instruct the first PU 102 where to write the data in the common memory 113, and unless the second PU 103 already is aware of where the specific data is stored in the common memory 113, the controller 101 will instruct the second PU 103 where to access the data in the memory 113.

In practice, when a UE (e.g. the first UE 111) is scheduled by the MAC scheduler implemented in the controller 101, the MAC scheduler includes a pointer with the scheduling instruction to UE specific data stored in the common memory 113, such as the previously mentioned HARQ data.

The common memory 113 may also be used to store data required for generating and receiving cell-specific signals such as single side band (SSB) data and Physical Random Access Channel (PRACH) signalling data. This allows processing of cell-specific channels to be taken over by a PU.

The first PU 102 serving the first UE 111 updates the data in the memory 113 for the specific slot being scheduled. When the first UE 111 is served by the first PU 102, access to the memory is handed back to the MAC scheduler of the controller 112. In next slot, serving of the first UE 111 may be handed over to the second PU and any required data is already stored in the common memory 113. As previously mentioned, the controller 101 may inform the second PU 103 accordingly. With the common memory 113, there is advantageously no need to transfer data between the PUs, since each PU 102-105 may turn to the memory 113 for the required UE data.

Thus, with reference to the flowchart of FIG. 3, before the first PU 102 is set in low-power mode, the first PU 102 is instructed by the controller 101 in step S102a where to write any required data for the first UE 111 and the second UE 112 in the common memory 113.

Further, before or after the second PU 103 is assigned to take over the serving of the first UE 111 and the second UE 112 from the first PU 102, the controller 101 instructs the second PU 103 in step S104a where to read the required UE data previously written to the memory 113 by the first PU 102.

In an embodiment, rather than measuring instantaneous traffic load, average load is measured or estimated over an appropriately selected time period to avoid any instantaneous peaks.

As illustrated in FIG. 2, for a given traffic scenario, historical traffic load data may be utilized to estimate any upcoming traffic load. In practice, average traffic load typically has a periodic or at least semi-periodic variation.

As is understood, many different parameters may be utilized to represent traffic load, such as data throughput, number of layers used, number of physical resource blocks (PRBs) allocated, etc.

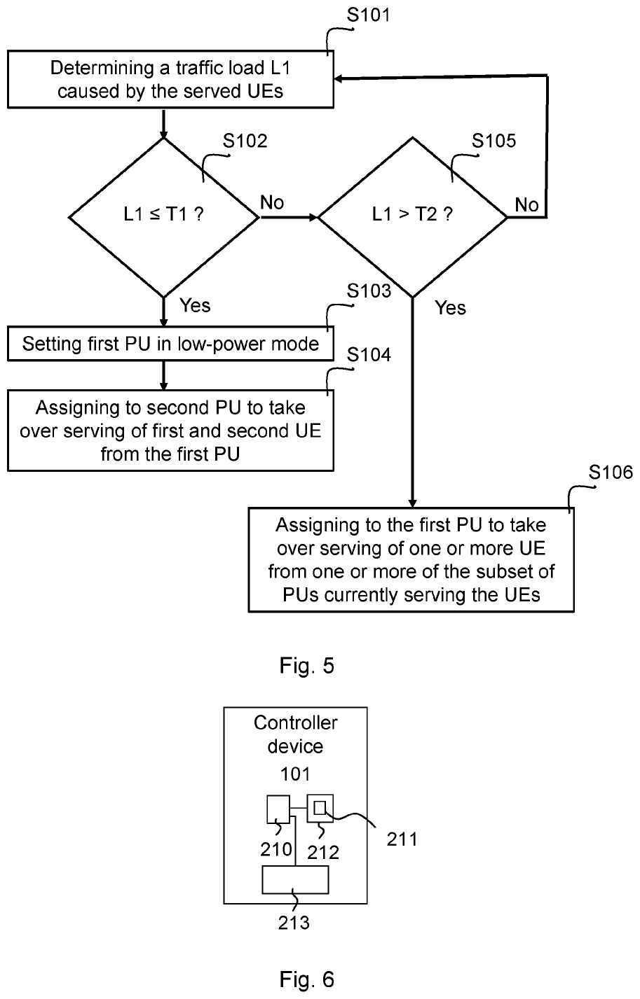

FIG. 5 illustrates a flowchart of a method according to a further embodiment where the controller 101 determines in step S105 whether or not the traffic load L1 of the served UEs exceeds a second load threshold value L2 indicating that the subset of PUs 103-105 no longer has capacity to serve the UEs given the increasing traffic load L1.

The second threshold value T2 is typically set slightly higher than the first threshold value T1 in order to introduce some hysteresis and thus avoid setting the first PU 102 in low-power mode and thereafter reactivating the first PU 102 to serve one or more of the UEs (or new UEs entering cells provided by the RBSs 106-109) in case the load slightly increases and exceeds T1.

Hence, if the traffic load L1 of the UEs is determined by the controller 101 to increase above the second threshold value T2 in step S105, the controller 101 will reactivate the currently powered-down first PU 102 and reassign to the first PU 102 in step S106 a task to serve one or more of the UEs in order to provide sufficient capacity to handle the UEs given the increasing traffic load L1.

For instance, the first PU may take over the task of serving the first UE 111 and the second UE 112 from the second PU 103, if that would free up sufficient capacity at the second PU 103.

Advantageously, with the embodiment illustrated with reference to FIG. 5, hardware utilization—i.e. number of PUs being powered-down—is dynamically adapted to fit an actual traffic load rather than a peak load requiring a maximum processing capacity of the PUs 102-105, thereby also adapting energy consumption to actual network requirements. As can be seen, any currently non-required PU is set in low-power mode resulting in reduced energy consumption, but may well be reactivated if processing requirements are increased.

Hence, only a few PUs is used in a low load scenario, while a full pool of PUs may be used during peak conditions.

FIG. 6 illustrates a controller device 101 configured to control processing resources of processing units being assigned to serve wireless communication devices in a radio access network according to an embodiment. The steps of the method performed by the device 101 are in practice performed by a processing unit 210 embodied in the form of one or more microprocessors arranged to execute a computer program 211 downloaded to a suitable storage volatile medium 212 associated with the microprocessor, such as a Random Access Memory (RAM), or a non-volatile storage medium such as a Flash memory or a hard disk drive. The processing unit 210 is arranged to cause the device 101 to carry out the method according to embodiments described herein, when the appropriate computer program 211 comprising computer-executable instructions is downloaded to the storage medium 212 and executed by the processing unit 210. The storage medium 212 may also be a computer program product comprising the computer program 211. Alternatively, the computer program 211 may be transferred to the storage medium 212 by means of a suitable computer program product, such as a Digital Versatile Disc (DVD) or a memory stick. As a further alternative, the computer program 211 may be downloaded to the storage medium 212 over a network. The processing unit 210 may alternatively be embodied in the form of a DSP, an ASIC, an FPGA, a CPLD, etc. The device 101 further comprises an interface 213 over which data may be received and transmitted.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a controller device of controlling processing resources of processing units being assigned to serve wireless communication devices in a radio access network, comprising:
determining a traffic load of the served wireless communication devices;
determining whether or not a subset of the processing units have sufficient processing capacity to serve the wireless communication devices based on the determined traffic load; and if so
setting at least one selected processing unit not included in said subset of processing units in low-power mode; and
assigning to one or more processing units included in said subset to take over serving of any wireless communication device served by the at least one selected processing unit being set in low-power mode.

2. The method of claim 1, wherein the assigning to one or more processing units included in said subset to take over serving of any wireless communication device served by the at least one selected processing unit being set in low-power mode comprises:
controlling a switched fronthaul configured to connect the processing units to the wireless communication devices to be served to switch said any wireless communication device to the one or more processing units included in said subset being assigned to take over the serving.

3. The method of claim 1, further comprising:
instructing the at least one selected processing unit where to write required data for said any wireless communication device in a memory common to the processing units before being set in low-power mode; and
instructing said one or more processing units included in said subset assigned to take over serving of said any wireless communication device where to read the required data in the common memory.

4. The method of claim 1, the subset of the processing units being determined to have sufficient processing capacity to serve the wireless communication devices if the determined traffic load does not exceed a first load threshold value.

5. The method of claim 1, further comprising:
determining whether or not a subset of the processing units still have sufficient processing capacity to serve the wireless communication devices based on a new determined traffic load; and if not
reassigning to said at least one selected processing unit being set in low-power mode to serve one or more of the wireless communication devices currently served by one or more processing units included in said subset.

6. The method of claim 5, the subset of the processing units being determined to not still have sufficient processing capacity to serve the wireless communication devices if the determined traffic load exceeds a second load threshold value.

7. The method of claim 1, wherein the determining of a traffic load of the served wireless communication devices comprises determining instantaneous traffic load or traffic load averaged over a time period, or estimating the traffic load from historical traffic load.

8. The method of claim 1, wherein the assigning to one or more processing units included in said subset to take over serving of any wireless communication device served by the at least one selected processing unit being set in low-power mode comprises assigning to said one or more processing units included in said subset to take over processing of cell-specific channels.

9. (canceled)

10. (canceled)

11. A controller device configured to control processing resources of processing units being assigned to serve wireless communication devices in a radio access network, the device comprising a processing unit and a memory, said memory containing instructions executable by said processing unit, whereby the device is operative to:
determine a traffic load of the served wireless communication devices;
determine whether or not a subset of the processing units have sufficient processing capacity to serve the wireless communication devices based on the determined traffic load; and if so to
set at least one selected processing unit not included in said subset of processing units in low-power mode; and to
assign to one or more processing units included in said subset to take over serving of any wireless communication device served by the at least one selected processing unit being set in low-power mode.

12. The device of claim 11, further being operative to, when assigning to one or more processing units included in said subset to take over serving of any wireless communication device served by the at least one selected processing unit being set in low-power mode:
control a switched fronthaul configured to connect the processing units to the wireless communication devices to be served to switch said any wireless communication device to the one or more processing units included in said subset being assigned to take over the serving.

13. The device of claim 11, further being operative to:
instruct the at least one selected processing unit where to write required data for said any wireless communication device in a memory common to the processing units before being set in low-power mode; and to
instruct said one or more processing units included in said subset assigned to take over serving of said any wireless communication device where to read the required data in the common memory.

14. The device of claim 11, further being operative to determine that the subset of the processing units have sufficient processing capacity to serve the wireless communication devices if the determined traffic load does not exceed a first load threshold value.

15. The device of claim 11, further being operative to:
determine whether or not a subset of the processing units still have sufficient processing capacity to serve the wireless communication devices based on a new determined traffic load; and if not to
reassign to said at least one selected processing unit being set in low-power mode to serve one or more of the wireless communication devices currently served by one or more processing units included in said subset.

16. The device of claim 11, further being operative to determine that the subset of the processing units still not have sufficient processing capacity to serve the wireless communication devices if the determined traffic load exceeds a second load threshold value.

17. The device of claim 11, further being operative to, when determining a traffic load of the served wireless communication devices, determine instantaneous traffic load or traffic load averaged over a time period, or to estimate the traffic load from historical traffic load.

18. The device of claim 11, further being operative to, when assigning to one or more processing units included in said subset to take over serving of any wireless communication device served by the at least one selected processing unit being set in low-power mode, assigning to said one or more processing units included in said subset to take over processing of cell-specific channels.
